(19) United States
(12) Patent Application Publication
(10) Pub. No.: US 2022/0103002 A1
(43) Pub. Date: Mar. 31, 2022

(54) Wireless Device Charging Pad

(71) Applicant: Keith Marz, Sherman Oaks, CA (US)

(72) Inventor: Keith Marz, Sherman Oaks, CA (US)

(21) Appl. No.: 17/037,685

(22) Filed: Sep. 30, 2020

(51) Int. Cl. H02J 7/04; H02J 50/10; H02J 7/00; H02J 50/40; H02J 7/34

(52) U.S. Cl. CPC H02J 7/04; H02J 50/10; H02J 7/0029; H02J 2207/20; H02J 7/0049; H02J 7/342; H02J 50/402

(57) ABSTRACT

A wireless device charging pad (WDCP) that is laid on a surface such as a tabletop and will wirelessly charge a device such as a wireless phone or table computer that is placed on the pad. The WDCP has two substrates, with a charging system sandwiched between the substrates. The charging system comprises a board, batteries each with a charge and discharge protection circuit, boost converters, and an external battery charger that receives power from a power source such ad home or business utility power. The battery charger plugs into the WDCP and provides power to the charging system. Once the charging system is charged, a person simply places their wireless device on the pad, which then automatically wirelessly charges the wireless device.

### TECHNICAL FIELD

The invention generally pertains to wireless charging devices, and more particularly to a wireless device charging pad that is placed on a surface such as a tabletop and wireless charges a device that is placed on the pad.

### BACKGROUND ART

In the modern world, wireless charging systems for wireless devices such as phones and tablet computers are widely used. Wireless charging allows a person to charge a wireless device battery without the requirement of plugging the device, via a cable, into a power source.

Wireless charging for cell phones was first introduced in 2011 by Samsung to the “Droid” (model Sch-1510) and years later to the Galaxy S4.

Note: could not find what wireless system they were using. (see note below*).

In the United States, the Federal Communications Commission (FCC) provided its first certification for a wireless transmission charging system in December 2016. (Again the is no mention of what system they approved?).

Note: there are two wireless charging systems currently available. They are NOT compatible.

The more popular of the two systems is the “Qi” system (pronounced “CHEE”). The second system was developed by POWERMAT and is called “PMA”.

It is estimated that roughly 90% of the mobile wireless charging systems are adapting the “Qi” system over the PMA charging system. It is by far the more popular of the two available systems. (No mention is made as to why the Qi system is overwhelmingly more popular and is being chosen over the PMA system. It may be cheaper to produce or charge more cost effectively).

However, in 2014, Nokia and AT&T removed the “Qi” system from their devices and started using the “PMA” format. (I think Nokia makes the cell phones for AT&T but I'm not sure, I could not find a reason why they did this).

A search of the prior art did not disclose any literature or patents that read directly on the claims of the instant invention. However, the following U.S. patents are considered related:

| PATENT NO. | INVENTOR | ISSUED |
|---|---|---|
| 2014/0239888 | Chen | Aug. 28, 2014 |
| 2017/0117742 | Nakhjiri | Apr. 27, 2017 |
| 2017/0310147 | Wu | Oct. 26, 2017 |

The 2014/0239888 publication discloses a wireless charge that includes an anti-slippery charger mat having a mat, inductive charger, power circuit board and a plug. A portable charging connector of the wireless charger includes a casing, power inductor, receiving hole indicator and a connector terminal. The plug is inserted into a power socket of a vehicle, and the portable charging connector is inserted into the inductive charge so that a device connected to the connector terminal can be powered or charged. The anti-slippery charger mat placed on top of a dashboard of a vehicle is capable of holding objects placed on it.

The 2017/0117742 publication discloses a wireless charger that is light-weight, thin, and can be hidden and/or integrated inside of handbags, backpacks, jackets, and other accessories. The wireless charger can also be used a standalone product. The wireless charger charges phones using wireless power transmission and incorporates a battery which can be recharged.

The 2017/70310147 publication discloses a wireless charger that includes a transmitting coil to induce charging of a target device, a printed circuit board, a charger casing to include the transmitting coil and the printed circuit board, and a thermally conductive coating to dissipate heat. The transmitting coil may include at least one electrically conducting coil.

For background purposes and indicative of the art to which the invention relates, reference may be made to the following remaining patents found in the patent search.

| PATENT NO. | INVENTOR | ISSUED |
|---|---|---|
| 8,610,398 | Lee, et al | Dec. 17, 2013 |
| 9,419,465 | Van Lammeren, et al | Aug. 16, 2016 |
| 9,537,345 | Wang, | Jan. 3, 2017 |
| 9,800,080 | Leabman, et al | Oct. 24, 2017 |
| 9,876,385 | Kuczek, et al | Jan. 23, 2018 |
| 10,283,998 | Hong | May 7, 2019 |
| 2015/0326060 | Young | Nov. 12, 2015 |

### DISCLOSURE OF THE INVENTION

A wireless device charging pad (WDCP) that is laid on a surface such as a tabletop and will wirelessly charge a device such as a wireless phone or tablet computer that is placed on the pad.

The WDCP is comprised of a first substrate with an upper surface and a lower surface and a second substrate with an upper surface and a lower surface. The two substrates preferably have the same dimensions and are secured together by attachment means such as an adhesive. The substrates can be made of various materials including plastic, a fabric, paper, cardboard or a synthetic material. Sandwiched between the two substrates is a changing system comprising charging coils, a multi-coil charging board, batteries each with a charge and discharge protection circuit, boost converters, and an eternal battery charger. A home or business utility power is supplied to the battery charger, which is plugged into, via a cable, the WDCP to charge the WDCP's batteries.

Once the WFCP's batteries are charged, a wireless device having wireless charging capability is placed on the upper surface of the second substrate, above the charging coils. The WDCP then wirelessly supplies power to the device, thereby charging the device.

In an alternate design, the charging system only, without the substrates is embedded into a surface such as a chair, arrest, a tabletop, a vehicle center divider, an airplane seat armrest or a sofa end.

In view of the above disclosure, the primary object of the invention is to provide a wireless device charging pad that is laid on a surface and will charge a wireless device that is placed on the pad.

In addition to the primary object, it is also an object of the invention to provide a wireless device charging pad that:
is easy to use,
requires no maintenance,
is easy to clean,
can be used on a variety of surfaces in many locations,
can charge multiple devices on a single pad,
is safe to use,
allows a person to charge a wireless device at a location close by, within arm reach,
can include advertising or other indicia, can charge any wireless charging capable device,
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a top plan view showing a wireless device charging pad (WDCP) with a cutaway showing a charging system within the WDCP.

FIG. 2 is an elevational side view showing the WDCP two substrates and attachment means.

FIG. 3 is a top plan view showing multiple WDCPs placed on a tabletop.

FIG. 4 is an orthographic view showing the WDCP charging system, with five charging coils.

FIG. 5 is a block diagram of the WDCP charging system.

FIG. 6 is a top plan view showing a chair, with a cutaway showing the charging system placed within one of the charging armrests.

### BEST MODE FOR CARRYING OUT THE INVENTION

The best mode for carrying out the invention is presented in terms that disclose a primary embodiment of a wireless device charging pad (WDCP). In addition to the pad embodiment, which is preferably a placemat design, a wireless device charging system that can be place within various locations is also disclosed. The WDCP is designed to wirelessly provide charging power to a device that is capable of being wirelessly charged. For the purpose of this disclosure the wireless device will be referred to and shown as a wireless phone. Also, if desired, indicia 66, such as advertising or instructions for use, can be placed on the placemat.

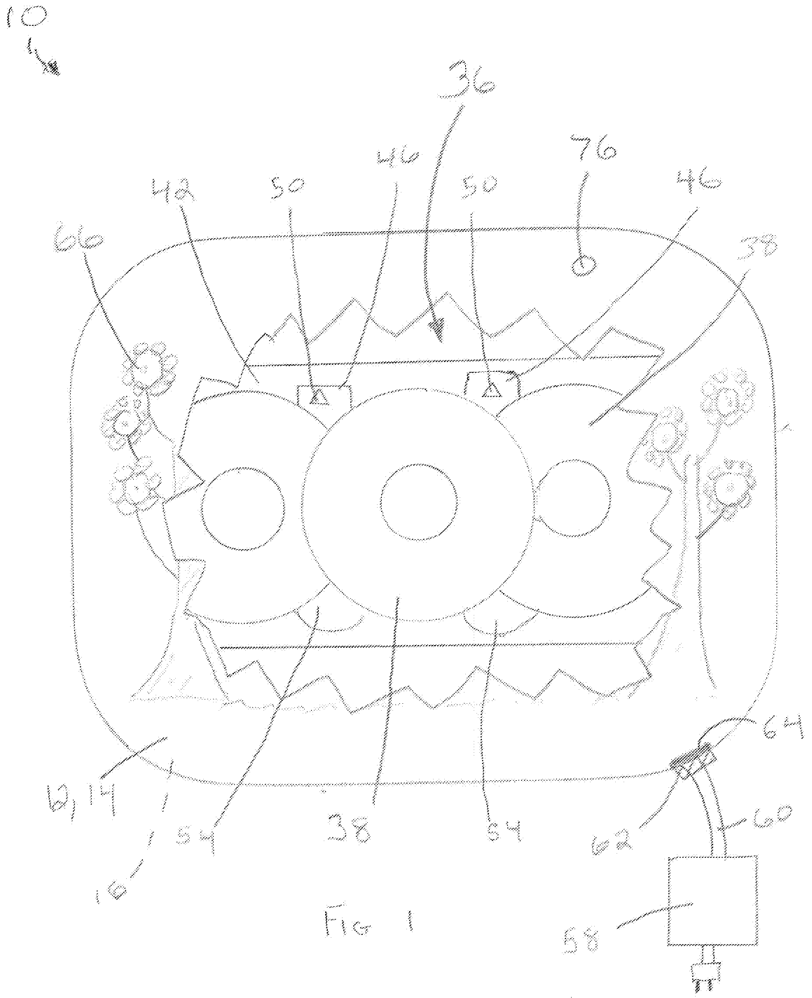

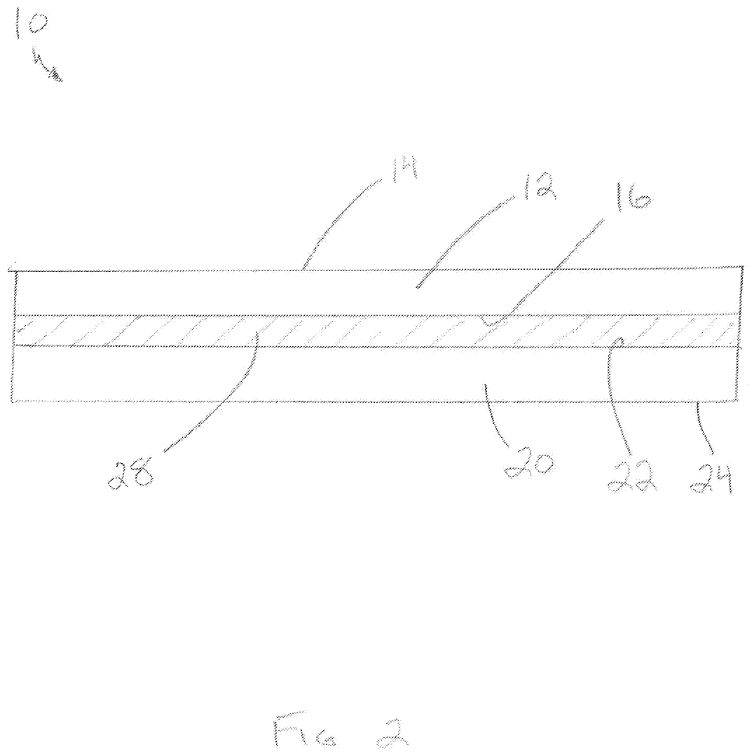

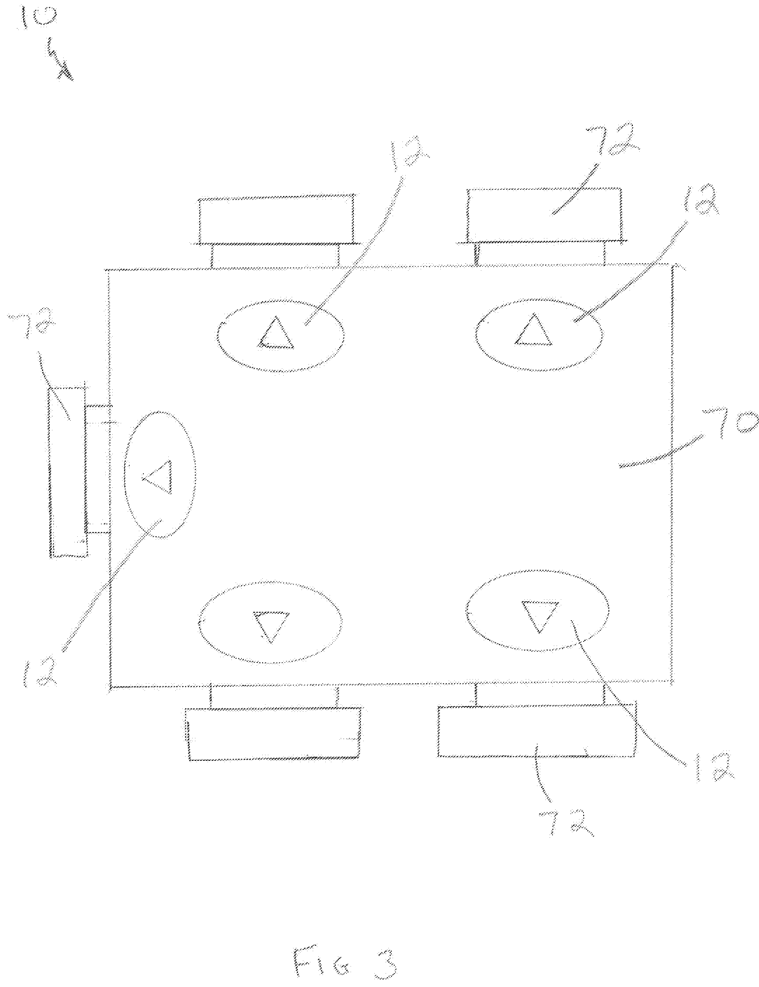

As shown in FIGS. 1-6, the WDCP 10 is comprised of a first substrate 12 with an upper surface 14 and a lower surface 16, a second substrate 20 with an upper surface 22 and a 25 lower surface 24. The two substrates 12,20 preferably have equal dimensions and are secured together by attachment means 28 which can include an adhesive, heat bonding, stitching or male and female detents.

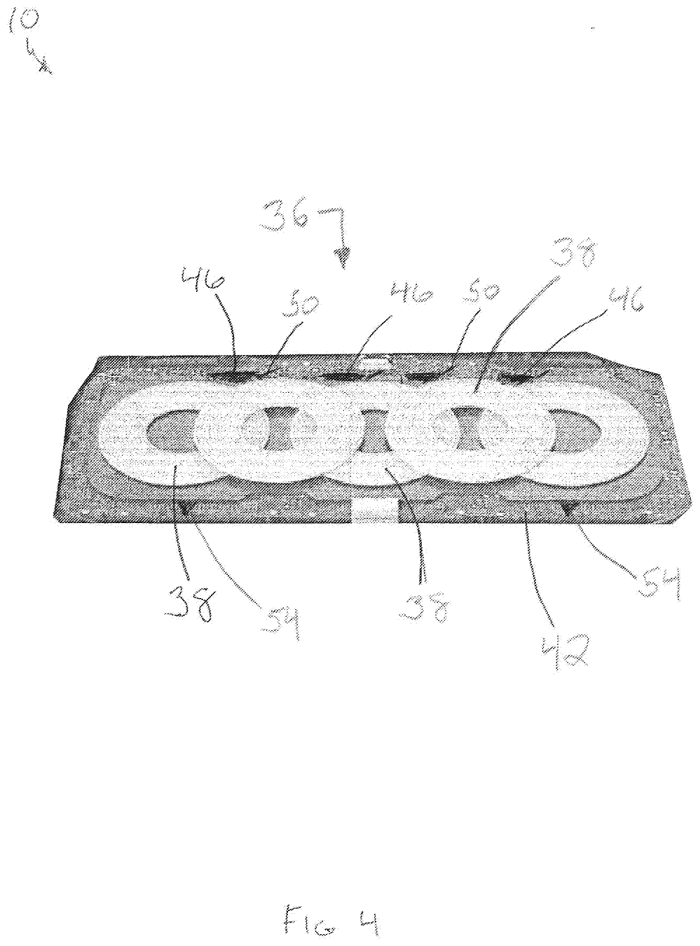

Sandwiched between the two substrates 12,20 is a charging system 36, as shown in FIGS. 1 and 4, comprising at least one and preferably multiple charging coils 38, a multi-coil charging board 41, at least one and preferably multiple batteries 46 with each battery having a charge and discharge protection circuit, at least one preferably multiple boost converters, and an eternal battery charger 58. Extending from the battery charger 58 is a cable 60 with a male input plug 62 at a distal end. The input plug 62 is inserted into a female input plug on the WDCP 10 and connected to the charging system.

The system 10 works by magnetic coupling between a charger that functions as a transmitter, and a receiver unit consisting of a wireless phone. The charging system is creating a transformer between the charging unit (the primary of the transformer) and the wireless phone (the secondary of the transformer).

There is no limit to the number of charging coils that can be implemented. The only drawback is that each coil requires charging circuitry. It is not possible to connect one multi-coil charging board to more than one charging coil. Using available technology that has been FCC approved, each charging coil and its associated multi-coil charging board presently require a power supply of 5 volts DC at 1 ampere or more of current.

A main inventive concept of the WDCP 10 is to increase the number of charging coils which will enlarge the charging area to such a degree as to enable a user to place a phone down nearly anywhere on the WDCP and have the phone connect and start charging.

The WDCP 10 is preferably configured as a placement for a table. The charger can be easily swapped out with a freshly charged unit after its charging capacity has diminished. It should be noted that the WDCP 10 is only about ¼ to ⅜″ inches in thickness at most. In essence, the entire tabletop could be covered with WDCPs or multiple charging systems could be embedded into the top of the table.

In order to accomplish this, the use of low profile components are necessary (surface mount components would be the preferred choice).

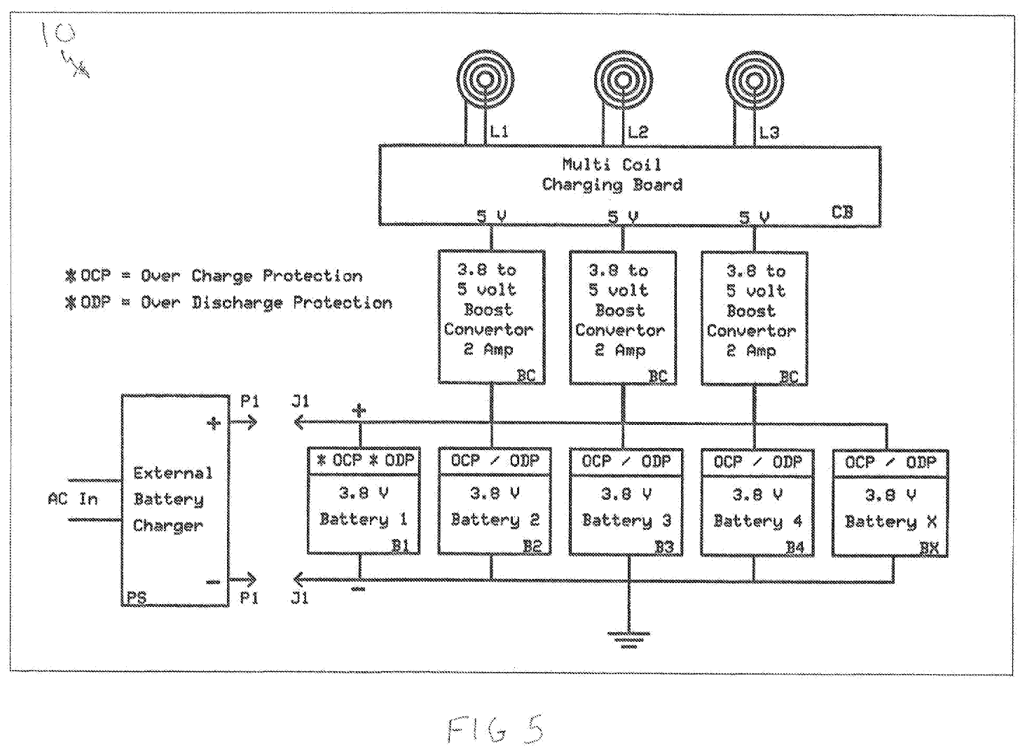

As shown in FIGS. 1 and 5, for the purpose of disclosure, the WDCP 10 utilizes three (3) charging coils, L1, L2 and L3, or five charging coils, as shown in FIG. 4. The charging coils are the primary windings of the transformer as previously disclosed. The charging coils are operated and controlled by the multi coil charging board (CB). The charging board has the following functions.

to determine if a wireless phone is in range and properly oriented in order to be charged. In other words, properly positioned over the charging coils L1, L2 or L3.

If the above criteria is met, then the charging board circuit (CB) will activate (energize) one or more of the three charging coils L1, L2 or L3 thereby providing power to the receiving coil in the wireless phone or to a wireless phone charger adapter for use with a wireless phone not capable of being charged wirelessly. The wireless phone will then start to charge its battery. The multi-coil charging board (CB) will continue to provide charging power to the wireless phone until the phone is removed from the WDCP 10.

Depending on the design of the multi-coil charging board 42, power to the charging coils will be turned OFF when the wireless phone battery is charged and no longer drawing current from the charging coils L1, L2 or L3. Or in all cases when the wireless phone is removed from the WDCP.

Power to the multi-coil charging board 42 and to the charging coils 38 is provided by one or more of the batteries 46 (B1 through Bx). These batteries are specifically chosen to provide also and they are high density batteries meaning that they provide a significant amount of power for their physical size compared to other batteries currently available. The type of battery utilized is known as a Lithium Ion (Li-Ion). This type of battery has specific charge and discharge requirements that are critical not only to battery operation and battery life but also for safety.

The batteries 46 can not be overcharged or over discharge. To do so would diminish battery life and in the case of overcharging can cause the battery to explode. To prevent this the batteries have a charge and discharge protection circuit 50 built in. This circuit physically disconnects a battery output when a battery is either fully charged or discharged.

The charge and discharge protection circuitry is shown as an element of each battery in FIG. 1, and shown in the block diagram of FIG. 5 on each battery (B1-Bx) as OCP Over Charge Protection and ODP Discharge Protection.

It should be noted that not all batteries have a charge and discharge protection circuitry built in. In some cases the circuit is external to the battery and instead built into the circuitry of the wireless phone. However, the circuit must be present somewhere in the any system using this type of battery when the batteries have the OCP and the ODP built in. If the batteries do not have the circuit then the circuit must be added to ensure long battery life and more importantly to ensure safe charging and discharging of the batteries.

The batteries 46, as shown in FIG. 1, are connected in parallel. This is done for two reasons:

To greatly increases the output current of the batteries system. When connected in parallel the total current available is greatly increased. The total current is the sum of all the individual batteries use. This greatly increases the batteries ability to charge a wireless phone for a longer period of time. The batteries must all have of the same current output. Different battery models or types can not be used together, and.

As shown in FIG. 1, the battery output voltage is 3.8 volts when fully charged. To correct for the difference in voltage between the battery output voltage of 3.8 volts and the multi coil charging board (CB) input requirement of 5 volts the boost converter 54 (BC) is utilized for each of the charging coils L1 to L3. There are many types of boost converters available. The boost converter preferred, as shown in FIG. 1, is a small low profile configuration. An adjustment potentiometer (not shown) is mounted horizontally to minimize the height of the multi-coil charging board. This is important in order to keep the height or thickness of the charging system 36 to a minimum ¼ to ⅜^{th} of an inch.

The boost converter 54 takes the 3.8 volt output of the batteries and boost the output to 5 volts at 1 amp which is the input voltage and current requirements of the multi coil charging board.

The specifications for the preferred boost converter (Model MT 3608) are:

Input voltage 2-24 volts DC,

Output Voltage (Adjustable from) 5.0-28 volts DC,

Output Current 1 ampere continuous (2.0 amperes maximum for short duration).

A second advantage to using the boost converter 54 is that it lengthens the wireless charge time of the WDCP 10 before the need to recharge the batteries. As the batteries 46 get used, the output voltage will drop from 3.8 volts. The boost converter 54 will maintain a constant 5 volts output at 1 amp to the multi cell charging board as the battery voltage begins to drop from being fully charged. In reality, the boost converter 54 will maintain the 5 volts out until the ODP (Over Discharge Protection) circuit begins functioning and terminates the battery output voltage, In other words, the ODP will disconnect the battery 46 from the circuit to prevent it from discharging too far and damaging the battery.

The final element of the charging system is the external battery charger 58 (PS), as shown in FIG. 1. The battery charger 58 has a cable 60 with a male input plug 62 at a distal end. The male plug is inserted into a corresponding female input plug 64 on the WDCP 10. Since all the batteries 46 are connected in parallel and are all the same type then any standard 5 volt power supply can be utilized. Since the batteries are only charged to 4.2 volts, a 5 volt de power supply will suffice. Since each battery incorporates its own charge and discharge protection circuitry, there is no need for a special charging system which is normally the case for charging multiple lithium batteries. The heavier duty the power supply used, the shorter the charge time of the batteries.

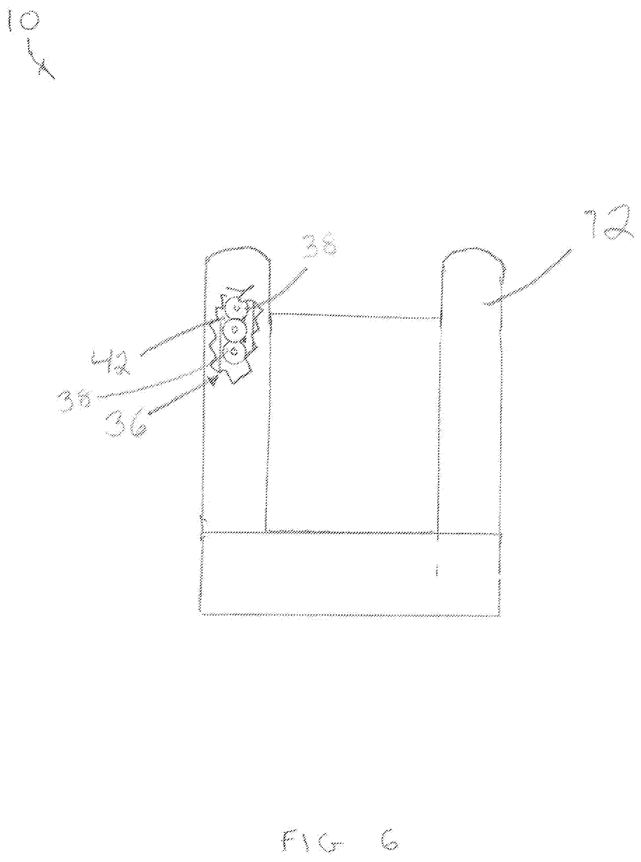

In addition to the WDCP 10 design as a placemat, as shown in FIGS. 1-3, that is laid on a surface such as a tabletop, the charging system 36 can be used without the substrates. As shown in FIG. 6, the charging system can be placed within, or embedded within chair armrest, a tabletop, a vehicle a center divider, an airplane set armrest, or a sofa end. With a charging system within one (or more) of these locations, a wireless phone is simply placed on the location, above the charging coils. As in the case of the placement design, the wireless phone will be charged as long as the phone remains on the charging system. Also, the WDP 10 either as a placemat or just the charging system, can include an indicator 76, as shown in FIG. 1. The indicator 76 is preferably a light but can also be an audio indicator that displays the level of charging, bow much charging power is available, and/or how many wireless phones are being charged at one time.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A wireless device charging pad comprising:
a first substrate configured with
an upper surface,
a lower surface,
a second substrate configured with
an upper surface,
a lower surface,
attachment means for securing the first substrate to the second substrate,
a charging system configured between the first substrate and second substrate, and comprising:
at least one charging coil,
a multi coil charging board,
at least one battery,
a charge and discharge protection circuit, and
a boost converter.

2. A wireless device charging pad of claim 1, wherein the first substrate and second substrate are configured as a tabletop placemat.

3. A wireless device charging pad of claim 1, wherein the first substrate and second substrate are made of a material selected from the group consisting of plastic, fabric, paper, cardboard, and a synthetic material.

4. A wireless device charging pad of claim 1, wherein the attachment means are selected from the group consisting of an adhesive, heat bonding, stitching, stapes and male to female detents.

5. A wireless device charging pad of claim 1, wherein the at least one charging coil is configured as primary winding of a transformer that is created between the charging system and the wireless device.

6. A wireless device charging pad of claim 1, wherein the multi-coil charging board interfaces with, operates and controls the at least one charging coil.

7. A wireless device charging pad of claim 1, wherein the at lest one battery is comprised of a high density lithium ion battery that is configured to power the at least one charging coil and multi-coil charging board.

8. A wireless device charging pad of claim 1, wherein the charge and discharge protection circuit is built in to the at least one battery.

9. A wireless device charging pad of claim 1, wherein the boost converter is incorporated into the at least one charging coil to correct for a difference in voltage between the battery output voltage of 3.8 volts and the multi-coil charging board voltage input requirement of 5-volts.

10. A wireless device charging pad of claim 1, wherein the external battery charger is connected to a power source and is comprises a cable extending from the battery charger and having a male plug at a distal end, the male plug inserted into the battery charging input, wherein once the wireless device charging pad is charging with power, a wireless device is placed on the upper surface of the second substrate above the at least one charging coil, thereby, charging the wireless devices and is wirelessly charged.

11. A wireless device charging pad comprising:
a first substrate configured with
an upper surface,
a lower surface,
a second substrate configured with
an upper surface,
a lower surface,
attachment means for securing the first substrate to the second substrate,
a charging system configured between the first substrate and second substrate, and comprising:
a plurality of charging coils, with each coil configured as a primary winding of a transformer that is created between the charging system and a wireless device,
a multi-coil charging board that interfaces with, operates and controls the charging coils,
a plurality of high density lithium ion batteries, each having a charge and discharge protection circuit that protects the battery from over charging, the batteries configured to power the charging coils and multi-coil charging board,
a plurality of boost converters, with one boost converter incorporated into one of the charging coils, the boost converter correcting for a difference in voltage between the battery output voltage of 3.8 volts and the multi-coil charging board voltage input requirement of 5-volts, and
an external battery charger that is connected to an external power source, and comprises a cable extending from the battery charger and having a male plug at a distal end, the male plug inserted into a battery charging female plug connected to the charging system, once the wireless charging pad is charged, a wireless device having wireless charging capability is placed on the upper surface of the second substrate above the charging coils, thereby, charging the wireless device.

12. The wireless device charging pad of claim 11, wherein the first substrate and second substrate are configured as a tabletop placemat.

13. The wireless device charging pad of claim 11, wherein the first substrate and second substrate are made of a material selected from the group consisting of plastic, fabric, paper, cardboard, and a synthetic material.

14. The wireless device charging pad of claim 11, wherein the attachment means are selected from the group consisting of an adhesive, heat bonding, stitching, stapes and male to female detents.

15. The wireless device charging pad of claim 1, wherein a wireless device will continue to receive charging power until the wireless device is removed from the wireless device charging pad.

16. The wireless device charging pad of claim 1, wherein the battery charge and discharger protection circuit physically disconnects the battery output when the battery is fully charged or discharged.

17. The wireless device charging pad of claim 11, wherein the plurality of batteries are connected in parallel.

18. The wireless device charging pad of claim 11, wherein the boost converter lengthens the wireless device charging time before the batteries must be recharged.

19. The wireless device charging pad of claim 11, wherein the battery charging power source is comprised of home or business utility power.

20. The wireless device charging pad of claim 11, further comprising indicia including advertising or instructions for use on the upper surface of the second substrate.

21. A wireless device charging system that is embedded into a surface, the system comprising:
a plurality of charging coils, with each coil configured as a primary winding of a transformer that is created between the charging system and a wireless device,
a multi-coil charging board that interfaces with, operates and controls the charging coils,
a plurality of high density lithium ion batteries, each having a charge and discharge protection circuit that protects the battery from over charging, the batteries configured to power the charging coils and multi-coil charging board,
a plurality of boost converters, with one boost converter incorporated into one of the charging coils, the boost converter correcting for a difference in voltage between the battery output voltage of 3.8 volts and the multi-coil charging board voltage input requirement of 5-volts, and
an external battery charger that is connected to an external power source, and comprises a cable extending from the battery charger and having a male plug at a distal end, the male plug inserted into a battery charging female plug connected to the charging system, once the wireless charging pad is charged, a wireless device having wireless charging capability is placed on the upper surface of the second substrate above the charging coils, thereby, charging the wireless device.

22. The wireless device charging pad of claim 21, wherein the surface is selected from the group consisting of a chair armrest, a tabletop, a vehicle center divider, an airplane set armrest, and a sofa end.
